(19) United States
(12) Patent Application Publication
(10) Pub. No.: US 2006/0049933 A1
(43) Pub. Date: Mar. 9, 2006

(54) Method and apparatus for tactical planning

(76) Inventors: Sean P. Kelley, Tequesta, FL (US); Mark Newhouse, Hatboro, PA (US)

Correspondence Address: EDWARDS & ANGELL, LLP, P.O. BOX 55874, BOSTON, MA, 02205, US

(21) Appl. No.: 10/936,862

(22) Filed: Sep. 9, 2004

(51) Int. Cl. G08B 25/00; G08B 23/00; G08B 1/08

(52) U.S. Cl. 340/524; 340/539.13; 340/500

(57) ABSTRACT

A method and apparatus as provided for aiding in the strategy and tactical planning for emergency response teams by dividing a site into a plurality of locations and making 360° photographs of the site from each location. The site is interrogated at each location to obtain interrogation information of the site. Each of the photographs corresponding to each location and interrogation information for each location is stored on a computer-readable medium. A location of interest is selected and the photograph and interrogation information for the selected location are displayed.

### BACKGROUND OF THE INVENTION

1. Field of Invention

This invention is directed to a method and apparatus for facilitating tactical planning for intervention in crisis situations in structures, and more particularly, for mapping, in a virtual reality manner, a site where a tactical team must enter, prior to entering an area and providing that map to the tactical team prior to action to aid in tactical planning.

2. Background

Since tragedies such as the Columbine shooting as well as the rescue attempts after the Sep. 11, 2001 terrorist attacks, the standards for emergency readiness have been raised. One reason attributed to the high fatality rate in the Columbine incident, by way of example, is that law enforcement and rescue teams did not have immediate access to accurate and up-to-date illustrative site layouts to allow them to immediately plan a strategy and enter the scene. Rather, time was required to obtain floor plans and determine whether or not the floor plans were accurate to date prior to entering the building.

Therefore, it has now become accepted that meaningful response requires immediate access to accurate and illustrative site layouts, as well as information regarding anticipated problem spots (“hot zones”), situations, and contents at specific locations within the site associated with the layout.

One known product from Interactive Tactical Group has used high resolution, 360° panoramic digital imaging capture of the interiors of buildings to provide a virtual map of the interior of a building for use by tactical emergency response teams. These virtual maps provide panoramic 360° views of the interiors of the location in question. Furthermore, still photos of items of interest such as fuse boxes, alarms, storage cabinets and the like in specific areas may be interposed within the panoramic view associated with that specific area to provide a more detailed visual image.

The system has been beneficial in providing a real-time virtual walk-through of a facility prior to entrance of the facility by the response team. However, the system suffers in that it does not indicate to the response team what may be expected at each physical location within a site or other useful information regarding the shown location. Furthermore, it does not provide an indication of where that view, as shown, is in relation to the overall site. Therefore, there is no frame of reference or “feel” to the person with respect to how they have arrived at that site which they are viewing, or where that site is in relation to other potential hot spots or areas of interest.

Accordingly, a method and apparatus for assisting emergency response teams in tactical planning for response to an emergency is desired.

### SUMMARY OF THE INVENTION

A method for tactical planning for providing emergency services at a site, divides the site into a plurality of locations. A 360° photograph of the site is made from each location. The site is interrogated at each location to obtain interrogation information regarding the site. Each photograph corresponding to each location and the interrogation information for each location is stored on a computer readable medium. The photograph and interrogation information for the selected site is then displayed on a display device in a user-readable form.

In one embodiment, the interrogation information could include information about one of personnel, hazardous materials, electrical infrastructure, fluid infrastructure, or gas infrastructure and their anticipated positions in the locations at the site. Furthermore, because the photograph and information is stored on a computer-readable medium, the information and, if necessary, photograph can be updated as the status of the site changes.

In another embodiment, a blueprint of the site is prepared. Icons representing each location are mapped onto the blueprint at a position corresponding to the actual location of the location at the site. When a location is selected on the blueprint, the photograph and interrogation information for that location are displayed. The icon can turn into a directional icon pointing in the direction of view of the photograph as currently displayed.

### BRIEF DESCRIPTION OF THE DRAWINGS

For a fuller understanding of the invention, reference is had to the following description taken in connection with the following drawings in which:

FIG. 1 is a flow chart for the method of interrogating a site and obtaining interrogation information in accordance with the invention;

FIGS. 2a and 2b are flow charts for making photographs of each location within the site in accordance with the invention;

FIG. 3 is a flow chart for converting the photographs and information into a computer-readable and user-useable form in accordance with the invention;

FIG. 4 is a schematic image of a system for use in connection with the method in accordance with the invention;

FIG. 5 is a screenshot of the system in use in accordance with the invention; and

FIG. 6 is a flow chart for strategizing a tactical response in accordance with the invention.

### DETAILED DESCRIPTION OF THE INVENTION

The method and apparatus described below is a tool for aiding emergency or other types of response teams by preparing them to enter a site by providing them with a virtual reality view of the site prior to entering, along with pertinent information to aid the emergency response team member in planning how to respond to a given situation.

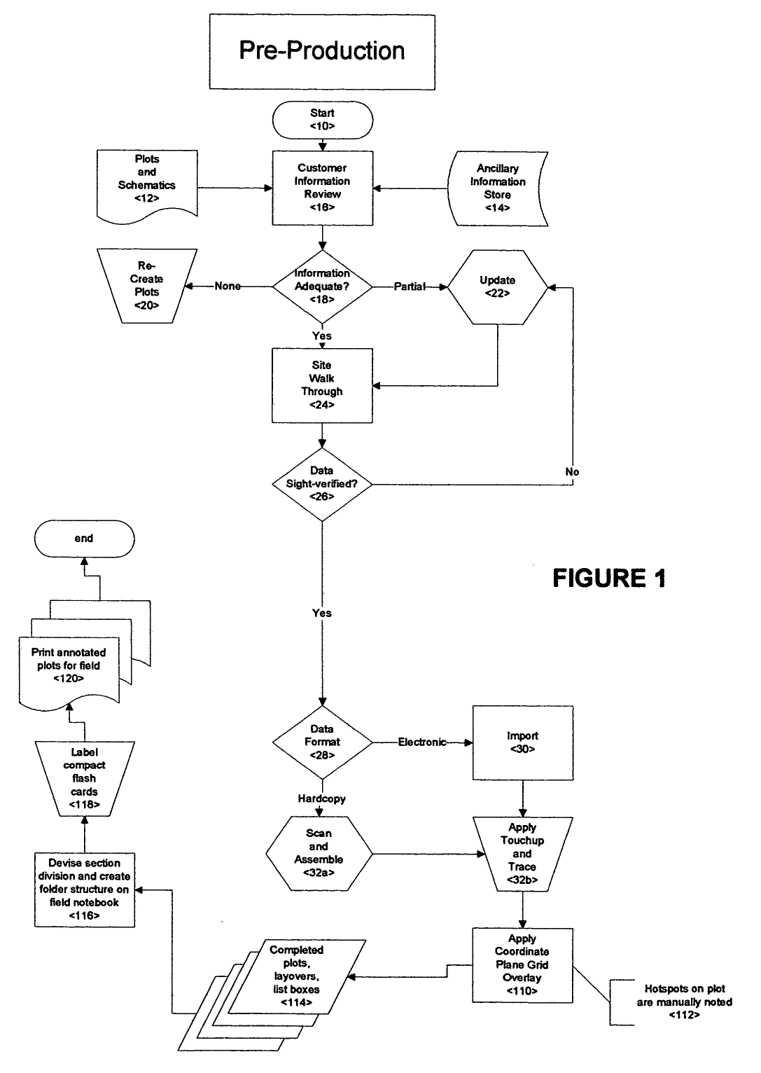

Reference is now made to FIG. 1 in which the method for interrogating the site for information is provided. When responding to an emergency, the most up-to-date information regarding potential hazards within the site is used by the officer. This information may correspond to hot spots at the locations within the site and will guide an appropriate response by the emergency response team. By way of example, if the site is a school and a chemistry lab is one location within the school site of interest, it would be of interest to the responding officer to know whether or not, by way of example, there are any toxic chemicals such as chlorine, acids, or at higher level learning schools, radioactive materials at the location and how they are stored. Even at a high school or junior high school, there may be natural gas for Bunsen burners or the like within the room. This information would be gathered and utilized for planning strategy for responding to a given situation.

Accordingly, the process begins in a step 10. In a step 12, information such as blueprints and schematics regarding the site, and if available, locations within the site are gathered to provide a graphical representation of the physical construct of the site. At the same time, in a step 14, the site is interrogated to gather ancillary information regarding the site and the various locations therein. This information makes up the interrogation information and includes information regarding materials which are stored at the various locations and, if hazardous materials are stored, instructions for dealing with those hazardous materials. It may also include personnel expected in a location, at what times, and identification information regarding those personnel. This may be in a way of a student roster if at a school, employee roster for commercial or government facility, photographs or other information where available. The information may include emergency-specific contact lists such as specific emergency (i.e., fire, police, ambulance, EPA, FBI or the like by way of example). If not included in the blueprint or schematics, the interrogation information could also include wiring, plumbing, HVAC, or even information regarding alarms, alarm codes, emergency shutoff instructions or the like. In short, any information, which a potential response team may find useful, would be gathered in step 14.

In a step 16, the information is reviewed to determine the information requirements for a site, how recently the information was prepared, i.e. is the information stale and of little value. In a step 18, it is determined whether the information is adequate. If the information is inadequate then research is done to create any necessary missing information in a step 20. If the information is only partially adequate, for example, some of the information is out of date or does not reflect some of the important information, then the information may be updated and amplified through research in a step 22 or a repeat of step 14. If the information is adequate, either initially or after updating in step 22, then a site walkthrough is conducted in a step 24. The site walkthrough is to confirm that the data, if adequate, is accurate. In effect, this is the due diligence for the information to ensure that at least at the time of preparation, it is both adequate and accurate to perform the necessary function, which is to aid an emergency worker in strategizing an approach to solving a situation.

In step 26, it is determined whether or not the data has been in fact verified. If the data is not verified, then it is updated and amplified in accordance with step 22 and the site walkthrough in step 24 is repeated. If the data has in fact been verified, then the information is formatted into a user-friendly format.

In step 28, the gathered data is formatted to be converted to a form, which can be later read by computer. If the data is electronic, or easily converted electronically by keyboard such as the type of information gathered in step 14, this type of soft information is imported to a computer in a step 30. If the information is in hard copy such as a schematic or a site plan, then in a step 32, the information is scanned and assembled to convert it into electronic format as is known in the art.

Utilizing various known software applications, such as Photoshop or Corel Draw Tool Suite as known in the art, in a step 32, the information is touched up and the blueprints and schematics may be traced to remove extraneous architectural information which, although required by architects, is not required by an emergency response team. Only the floor plan and the labeling of significant structures are provided in the contemplated invention, but whatever information is deemed to be of interest to a response officer may be included.

Next, locations within the site are identified and mapped to the blueprint. In step 110, a coordinate plane grid overlay is provided. Each area within the grid is identified as a location within the site in accordance with a step 110. In a step 112, hotspots, such as locations of anticipated personnel, hazardous materials, or other distinct areas, which contain situations of interest to potential response personnel, are manually noted at each location within the grid at the site.

The grid is overlaid to the electronically stored blueprints and schematics generated in step 32. In a step 114, the coordinate plane is plotted against the blueprints, a layover corresponding to the locations on the coordinate plane within the site is applied to the graphical representation of the site, and other layovers and lists of interest are mapped to coordinates on the grid so the information corresponding to the hotspot of the chemistry lab, as discussed above, would now be mapped to the location on the grid plane of the chemistry lab within the site.

It is then determined how to divide the locations into sections to facilitate the creation of a folder structure within the computer facilitating storage of the data within the computer-readable medium such as on a field notebook in a step 116. The data is now stored, at least temporarily, on a manipulateable portable computer readable medium in a step 118. In a preferred example, the data is stored on flashcards; however, CD ROMs or other like portable memory may be used. At the same time, a hard copy of the annotated plots of the site is printed in a step 120.

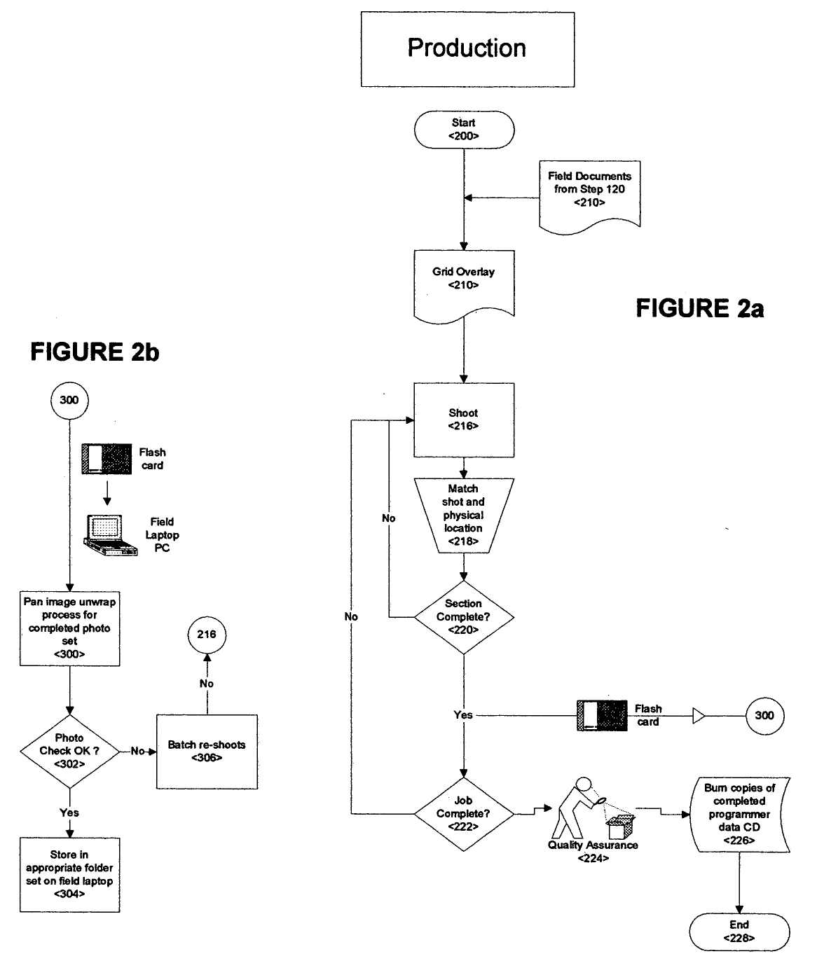

Reference is now made to FIG. 2a in which a method for obtaining the photographs at the physical site is provided. The process begins in a step 200, and the field documents prepared in step 118 and 120 are provided at the site in a step 210. In a step 212, the site is divided into a plurality of locations by preparing a physical grid overlay at the site to identify locations. The grid overlay as created at the site substantially corresponds to the grid overlay as mapped against the blueprints and schematics so that there is substantially a one-to-one correspondence between locations at the physical site and locations on the blueprint.

In a step 216, a 360° panoramic camera as known in the art, is physically placed at each successive location within the site as identified by the grid overlay. Pictures are then taken in a 360° direction. In other words, as in a preferred embodiment a fish-eyed lens is used, or a more conventional camera is rotated 360° from its physical location taking overlapping pictures. Furthermore, the camera may be panned upwards and downwards to photograph what is virtually a sphere and would be all views available to a person standing at the location of the camera.

In a step 218, the physical location of the shot is matched with the virtual location on the schematic blueprints as determined in steps 110,114. A hotspot index table, corresponding to those locations having interrogation type information such as hazardous materials, alarm codes, alarm locations, shutoff instructions, personnel locations or the like is generated at each location.

In a step 220 it is determined whether or not the “shoot” or the photographing of the location is complete. If the section is not complete, then the process returns to step 216 for continued photographing of the location. If “yes,” then it is determined in a step 222 whether or not the job is complete. If the job is not complete, the process returns to step 216 at another location. If the section is complete, then at the same time the photographs are stored in a step 221 on a memory device, such as a flashcard in a preferred embodiment, or a hard drive, CD or other memory device and the process moves to the process in FIG. 2b.

The process now moves to step 300 as each location is completed. As shown in FIG. 2b in step 300 the panoramic photograph stored on the flashcard for each location is unwrapped to complete a photo set for each location in accordance with step 301. The photo is then checked in a step 302 to determine if it is acceptable. If it is acceptable, it is stored in the appropriate folder on the field computer, such as a laptop, in a preferred embodiment by way of example, in a step 304. If the photographs do not unwrap well or are not acceptable, then in a step 306 the batch of photographs for that location is reshot by returning to step 216.

If it is determined that the job is complete in step 222, then a final quality assurance check is performed in a step 224. All of the photographs in the folder may then be copied onto a transportable machine-readable medium such as a CD ROM, flashcard, or the like is stored on a server in accordance with a step 226. The photography preparation for the system is then completed in step 228.

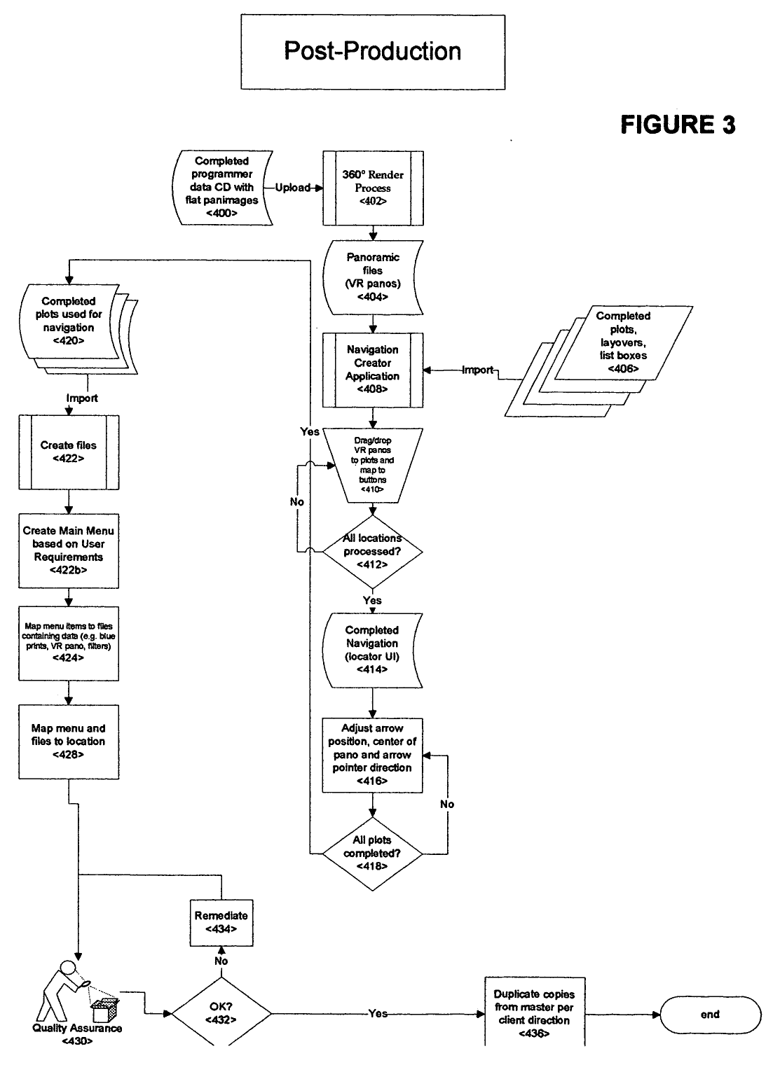

Once the interrogation data has been obtained and the photographs have been created, in a postproduction process the data is married to the photographs in a user-friendly format as shown in the method of FIG. 3.

In a step 400, the completed data CD ROM created in step 226 with flat panographic images are uploaded and pantographic photographs are converted to an immersive 360° movie, utilizing known software applications such as QuickTime VR as is known in the art in a step 402. These roughly stitched photographs are then converted to computer-displayable, panoramic images in a step 404 as known in the art. The completed graphical plots created in step 114, the layovers created in step 110 and 112, as well as a list of categories of interrogated information are imported in a step 406 onto the computer utilizing software applications such as QuickTime VR with a menu utilizing Director as is known in the art. In this way, the blueprints and schematics are married to the photographs so that a location on a blueprint as created in step 32 is now mapped to the location as photographed in step 216 and stored electronically as a mapped pair in a step 408.

To facilitate this, the photographs, associated data for each location, the blueprints and all other data are stored as object files and therefore may be easily cross-linked and mapped to each other. By marrying the photographs to the schematic/blueprint it enables a graphical user interface link between the two.

In a step 410, the hotspots are then mapped to the photographs as identified in the preproduction interrogation process. Hotspots are those areas which require further information, such as locations for materials, personnel or the like for which either extra precaution or extra steps need be taken. It is then determined in a step 412 whether all of the location has been processed. If not, step 410 is repeated until all hotspots and associated interrogation information have been mapped to the appropriate photograph.

If the location has been processed, then the final touches are added to the data, including such activities as in step 416, the adjustment of icon positions, including placing of an arrow on a schematic at a position corresponding to the photograph of a location to be displayed and aligning the direction of the arrow with the direction of the view as shown in the panoramic view. It is then determined whether adjustment has been made for all of the locations in a step 418. If not, step 416 is repeated for each location.

If the adjustment has been made, then the completed display is mapped with overlay information in a step 420. Overlay information includes graphic indicators associated with each location, which allow users to obtain specific interrogation information regarding the object as viewed using a graphical user interface. In a step 422, files are created identifying areas on the schematic of particular interest, i.e. the hotspots, as a function of their contents. For example, files are created with respect to hazardous materials, machinery at the site, plumbing, wiring, HVAC, types of people expected such as children versus adults, civilians versus military personnel, as well as the types of activities at a particular location, i.e., chemistry laboratory versus auditorium.

In step 422, a file of anticipated interrogations by the user of the system may also be created having certain generic questions such as “What materials?““Who is expected in the area?““Is this a hazardous materials area?“or the like. As will be described below, these questions may appear on the display to the user as prompts to facilitate and speed the strategizing process prior to entering the site.

In step 424, menus are created corresponding to the interrogation information created in the file. These are menus of desired interrogations, such as the specific questions identified above or the more generic categorical interrogations such as floor, equipment, blueprints, contents or the like which will provide graphical user interfaces to the files.

In Step 426, the menu items are mapped to the files containing the data stored as objects. In a step 428, the menus and the underlying files are then mapped to specific location photographs and their corresponding selected blueprint areas.

In a step 430, a quality assurance step is provided to determine in a step 432 whether the completed product is acceptable for use, if not, the product is corrected in a step 434. In a step 436, the information is copied onto a portable computer-readable device such as a CD ROM, flash card, or the like for use in a field laptop or notebook in a preferred embodiment. The CD ROM would include menu files, photograph files, schematic files and interrogation information files all mapped and in a computer-readable form to display a selected location within a site with its corresponding mapped interrogation information.

We note that a CD ROM is used by way of example. However, other portable storage devices, such as a flashcard, other ROM, or even dedicated personal data accessory (“PDA”) may be utilized. Additionally, the data need not be portable and could be stored on a server to which only authorized personnel would have access so that a wireless or landline-connected laptop could access the information in real time. There are benefits to both approaches. The use of a portable memory, by definition, makes the information more portable. However, storing of the information on a server makes the data more easily accessible and allows for real time updating of the data rather than reburning the data onto a portable data device so that the most up-to-date and accurate information may be made available to the user. Also, read/write CD ROM may be used, but is not preferred to prevent inadvertent data changes.

When the data is stored on a server, the stored information may also include links to third party data sources. By way of non-limiting example, if the emergency is hurricane evacuation, a link could be made to the hurricane evacuation routes stored at the county, state or local government. If there is an outbreak of some rare chemical, a real time treatment solution may be available from a Department of Environmental Protection site.

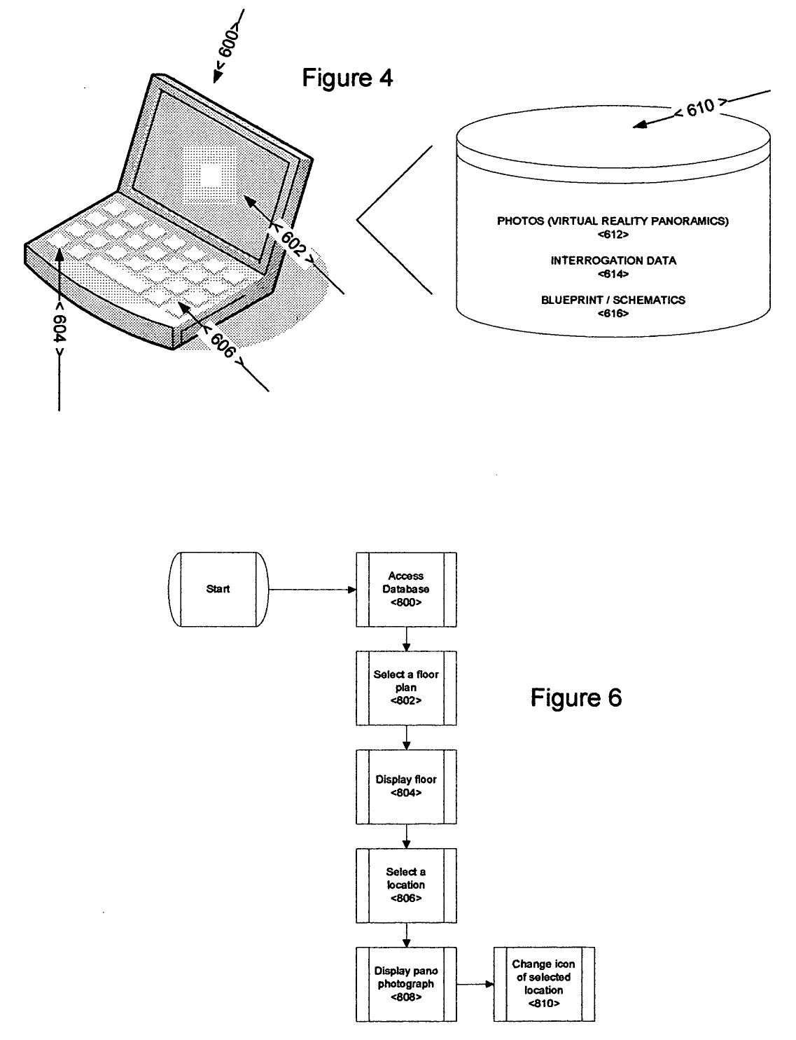

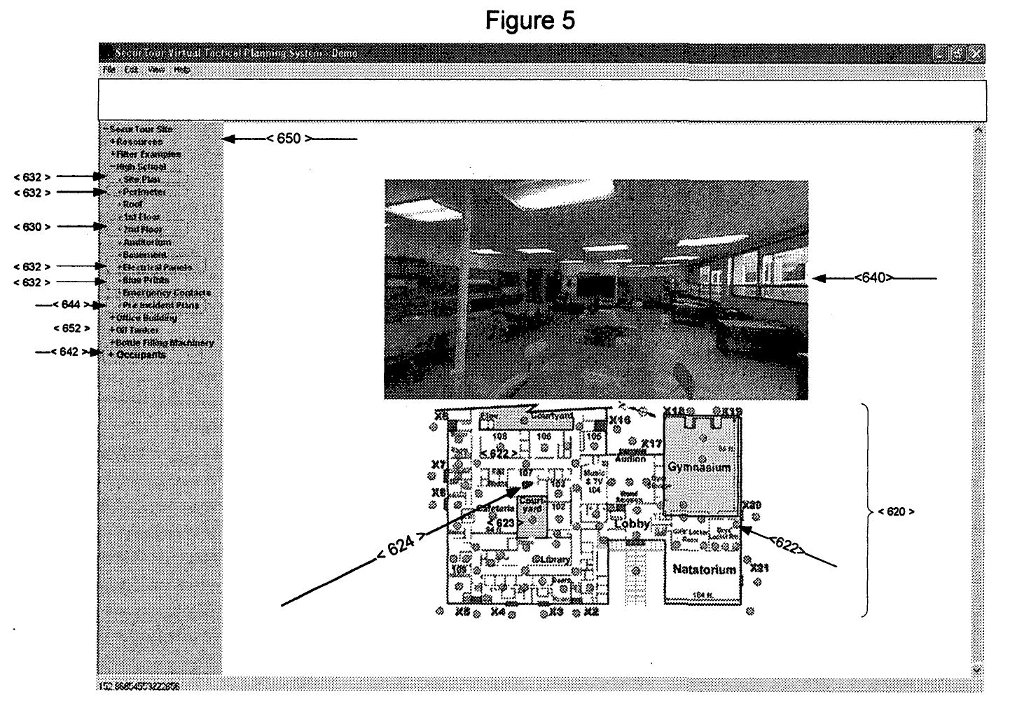

Reference is now made to FIGS. 4 and 5 in which the use of the completed system in the field is demonstrated. Any display device, which is capable of displaying stored data, may be used. In the preferred example, emergency response personnel would make use of a laptop or notebook computer 600 having a display 602, keyboard 604 and a mouse 606. A CD ROM is loaded into a display device such as a computer 600 and is schematically represented as a database 610 containing object files for the photographs 612 of each location within the site, interrogation files 614 for each location in the site and a schematic or blueprint 616 for the site, all of which are mapped and linked as discussed above so that when a location is identified on the blueprint schematic data 616, corresponding photograph data 612 and appropriate information data 614 is also called up. It should be noted that a wireless connection to a server could substitute for CD ROM 610.

When the CD ROM 610 is loaded it will display, as shown in FIG. 5, a blueprint 620 of the site and identifying by dots, or some other graphical interface, the locations 622. As noted, in some preferred embodiments, the schematic or blueprint may be annotated to include room number identifiers, room function identifiers such as gymnasium, cafeteria, courtyard, lobby or the like to further assist in identifying the area in question.

A menu 630 is also overlaid and presented to the user. The menu includes, in this instance, the generic interrogation information links 632 such as roof, blueprints, electrical panels, or the like by way of example. As described above, selection through a mouse, other graphical user interface, or other interface, such as entering the desired menu item by keyboard, will pull up the associated linked data for other floors, perhaps even including other blueprints 620. A specific location 624 is selected on blueprint 620 and causes a change in icon, such as a dot to an arrow to indicate the selected location. Once a location 624 is selected, a photograph 640 associated and mapped to that location 624 is displayed. Any graphical indicator such as change in color, change in shape or the like can be utilized to indicate that it is selected location 624 that has been selected. However, because photograph 640 is a panoramic photograph capable of being virtually viewed as if standing in the location, an arrow is preferred as the location 624 indicator to identify the direction in which the photograph is viewing the location to enable the user to virtually tour the room relative to the rest of the building.

It is also contemplated to link the hotspot interrogation information from the interrogation data 614 to the blueprint 616 and to cause the hotspots to be displayed in a manner to indicate to the user that a hotspot exists. For example, location 624 may include hazardous material storage and could be indicated with a color scheme for red for dangerous materials, whereas an area where people are expected, such as the gymnasium, may be color coded green and hallways which are not in use may be color coded blue to indicate the lowest number of possible situations at that location or even the lowest level of hazards or danger.

It should be noted that while the field 650 containing menu 630 is a link to other blueprints 620 within the site to link to other locations, at each specific location, either field 650 or an auxiliary field 652 may contain links to the interrogated information corresponding to that location such as anticipated occupants 642 or a disaster recovery plan 644. In a server-based embodiment it could be a link to a third party data source.

In this way, an emergency services respondent can arrive on site and take a virtual reality tour of the premises and interrogate the premises to answer specific questions regarding specific locations and prepare a strategy for responding to the emergency situation on site. In this way, there are no delays in waiting for gathering of the information, and by use of the virtual reality tour, it is if a walkthrough dress rehearsal had already been conducted. Furthermore, by making it portable and on a flashcard or CD ROM or the like, the response team may carry the virtual reality tour with them as they proceed through the building and compare the expected state of the location to the actual state of the location and act accordingly if something is out of order.

Reference is now made to FIG. 6 in which a flow chart for utilizing the data stored on the CD ROM or other database is provided. In a first step, the database for the site is accessed in a step 800 utilizing a display device. In a preferred embodiment the display device is a computer 600, but may be any device capable of manipulating the various data files, such as a laptop, notebook, PDA or other computer device and displaying the information. A user prompt, much like menu 650 is provided to the user who then selects a floor plan/blueprint 620 of the site corresponding to the area of interest in a step 802; this may be the perimeter, the roof, the first floor, the second floor or any other associated structure of the site. It should be noted that a building is used by way of example in this embodiment. However, this method and apparatus is equally applicable to any large structure such as an oil rig, a vehicle such as an airplane or boat or ship, even an outdoor structure having many obstacles and hidden structures such as an airport, bridge, tunnel, monument or the like.

In a step 804, the floor plan/blueprint 620 is displayed. In a step 806, a location 622 is selected causing, through the mapped data links, the display of the corresponding photograph and interrogation information links 652 on display 640. In a step 810, the icon at the selected location 624 is changed to indicate which of the icons has been selected.

It is possible in step 808 to change the display slightly by interrogating the information to obtain further interrogated information regarding the answers to the query made to field 652. It should also be noted that a drill down for specific information as is known in the art by utilizing Windows technology provided by Microsoft, in particular, may be utilized to provide more and more granular information. Furthermore, in step 806 or 808, the entire location and display may be changed by selecting a different floor plan 802 from menu 650 and the process may be repeated again.

By providing such a method and apparatus, emergency response teams can plan in real time their tactical strategy ahead of actually entering the location. Furthermore, scenarios and issues regarding how to approach certain areas, which are hotspots, can be addressed prior to going in. By utilizing the overlays in the fields of interrogated information the user can approach a variety of situations based upon full information.

It should be noted that although the system has been described for use in connection with emergency response, it lends itself to other uses. The system may be used in property management, business continuity planning, simulation training or casualty insurance documentation.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit and scope of the invention. It is the intention, therefore, to be limited only as indicated by the scope of the claims appended hereto.

It is also to be understood that the following claims are intended to cover all of the generic and specific features of the invention herein described and all statements of the scope of the invention, which is a matter of language, might be said to fall therebetween.

What is claimed is:

1. A method for tactically planning for an emergency response at a site comprising the steps of:
dividing the site into a plurality of locations; making a three hundred sixty degree photograph of the site from each location;
interrogating the site at each location to obtain interrogation information;
storing each photograph corresponding to each location and the interrogation information for each location of a site on a computer-readable medium;
selecting a location of interest;
displaying the photograph and interrogation information for the selected location on a display device.

2. The method of claim 1, further comprising:
creating blueprints of each site and plotting the plurality of locations on the blueprint;
displaying the blueprint containing the location of interest;
selecting the location of interest from the blueprint; and
displaying the photograph and interrogation information for the selected location on a display device.

3. The method of claim 1, further comprising mapping interrogation information for each location to a respective photograph of each location.

4. The method of claim 2, further comprising the step of changing the icon representing the location into an arrow, the arrow having a point, the point corresponding to the direction sight as displayed by the photograph.

5. The method of claim 1, wherein said interrogation information includes hotspot information.

6. The method of claim 5, wherein said hotspot information includes information regarding at least one of hazardous materials, personnel, and dangerous situations likely to exist at the selected location.

7. The method of claim 6, wherein the hotspot is indicated by a graphical indicator on the blueprint at the location.

8. The method of claim 1, wherein the computer-readable medium is the electronic memory of a server.

9. The method of claim 1, wherein the computer-readable medium is a CD ROM.

10. The method of claim 1, wherein the computer-readable medium is a flashcard.

11. The method of claim 8, wherein the interrogation information includes links to third-party data.

12. The method of claim 1, wherein the computer retrievable medium is a CD ROM.

13. A computer readable product comprising a computer-readable medium having computer readable data files embodied in said medium for causing said computer to display data for planning a strategy for responding to a an emergency situation at a site comprising:
a first computer readable file, the file having 360° photographs of the site from each of a plurality of locations;
a second computer readable data file containing interrogation information for each of said plurality of locations of a site, said interrogation information for each location being mapped to a respective 360° photograph for said location such that display of the photograph causes display of the corresponding interrogation information.

14. The computer readable product of claim 13 further comprising a third computer-readable file containing blueprints of the site and said blueprints having plotted thereon the plurality of locations, each location on the blueprint being linked to a corresponding 360° photograph for each said location and interrogation information for each said location such that the 360° photograph associated with a location of interest and the interrogation information for said location of interest is displayed when said blueprint is displayed and a location of interest is selected from said plurality of locations on said display.

15. The computer readable product of claim 13, wherein said computer readable product is a CD ROM.

16. The computer readable product of claim 13, wherein said computer readable product is a flashcard.

17. The computer readable product of claim 13, wherein said computer readable product is a server.

18. The method of claim 13, wherein said computer product is portable.

19. A method for tactically planning for an emergency response at a site utilizing a display device and database, said database having a 360° photograph at each of a plurality locations within a site and interrogation information for each location stored therein comprising steps of:
accessing said database;
selecting a location of interest;
displaying a 360° photograph of the location of interest; and
displaying interrogation information for the location of interest with the display of the photograph.

20. The method of claim 19, wherein blueprints plotted with each of said plurality of locations of the site thereon are stored in the database, and further comprising the steps of:
selecting a blueprint for the site; and
selecting the location of interest from the blueprint.

21. The method of claim 19, wherein said interrogation information includes hotspot information.

22. The method of claim 22, wherein said hotspot information includes information regarding at least one of hazardous materials, personnel, and dangerous situations likely to exist at the selected location.

23. The method of claim 19, wherein said database is portable.

24. The method of claim 19, wherein the display device is a computer.
